(19) United States
(12) Patent Application Publication
(10) Pub. No.: US 2012/0278380 A1
(43) Pub. Date: Nov. 1, 2012

(54) Outdoor Tracker System with Visual Communication Devices

(76) Inventors: Joseph Curran, Springboro, OH (US); Jeffrey Peltier, Sioux Falls, SD (US)

(21) Appl. No.: 13/097,407

(22) Filed: Apr. 29, 2011

(51) Int. Cl. G06F 15/16

(52) U.S. Cl. 709/203

(57) ABSTRACT

An outdoor tracker system includes a web-based computer with hunter/outdoorsman mapping software which provides a login interface for user registration requiring unique identifying information data for the user to enable logging into a hunter/outdoorsman website. Upon logging in, the software provides for designating a geographic location and generates a map with hunter/outdoorsman geographic location thereon for display or printing and a client computer having a web browser thereon operably connected to the web-based computer. An illuminating portable board is provided to display the map at the hunt/outdoor site, preferably on a vehicle. A marking slap stick is also provided for marking trees.

### FIELD OF THE INVENTION

The present invention relates to the field of hunting. More particularly, the invention relates to an outdoor tracker system with Visual Communication Devices alerting people, such as other hunters or outdoorsman, of their location thus making it a safer hunting/outdoor experience.

### BACKGROUND OF THE INVENTION

Public land recreation usage can be for various activities. Such public land users are generally ignored by the hunting industry as to their hunting practices. Sportsmen use the same area for activities such as hunting game, bird watching, horseback riding, fishing, hiking, and cycling to name a few.

Currently, there is no suitable method of reserving or identifying an intended use region for a particular outdoorsman. There are inadequate methods or systems of communicating one's location in outdoor environments.

The devices which exist for tracking or marking one's path in a field or wooded area are limited. Historically, these include marking a trail with some type of material, such as a sign or ribbon. Electronic systems which currently exist are limited to military or responder applications, or GPS devices which do not communicate a hunter/outdoorsman position to another hunter/outdoorsman utilizing the same location.

While these prior systems provide component(s) for locating or tracking, there remains a need for a more fully comprehensive system for use in alerting, locating and tracking hunters and/or outdoorsman. The instant invention provides an enhanced safe and convenient device for marking, locating and tracking a hunter or outdoorsman to render a safer hunting/outdoor experience.

### SUMMARY OF THE INVENTION

It is an object to improve hunting and outdoor activity.

It is a further object to improve hunting and outdoor safety.

It is another object to provide a system for alerting of one's location when hunting or conducting outdoor activity.

It is another object to provide a device for tracking one's hunting or outdoor position at a particular time and day.

It is still another object to provide a device for displaying a hunter's or outdoorsman's location on a vehicle, particularly the window of the vehicle.

It is still another object to provide a means of extending a courtesy to other hunters/outdoorsmen not previously available.

The present invention is directed to an outdoor tracker system with Visual Communication Devices. One aspect of the system includes a web-based computer based system operably associated with hunter/outdoorsman mapping software which includes a login interface requiring a username and password or other unique identifying information data, whereupon logging into the site, a hunter/outdoorsman location data is obtained either by selecting a location within the mapping program or by way of manual entry of longitudinal and latitudinal coordinates. Upon location data being obtained or entered, the software generates a map with the location of the hunter/outdoorsman thereon for display or printing. In addition, the hunter/outdoorsman mapping software provides for marking an anticipated date, time and location in which the hunter/outdoorsman is to be.

Another aspect of the invention includes portable vehicle display boards. The boards are preferably equipped with a water resistant display container having a transparent front surface, a map which bears a visual location of a hunter/outdoorsman's location and which is disposed in the container in a manner to be viewed through the transparent front surface. The container can preferably have a back surface equipped with a connector for connecting the container to the vehicle, such as a hook for hanging the container from a window. In addition, the container is preferably equipped with an illuminating device for illuminating the map. In one embodiment, the container can include a metal back surface and a magnet (preferably colored) which is movably disposed over the map to indicate the location of the hunter/outdoorsman. Optionally, the map can be printed bearing the location of the hunter/outdoorsman. The illuminating device can be powered via battery or solar power storage cell.

The invention also provides for a spring metal slap stick (such as a slap stick) bearing a fluorescent material on the surface thereon. Optionally, the metal stick can have a phosphorescent material which is chemiluminescence or made with a reflective material. The spring metal slap stick can preferably be of a sufficient length such as several feet long to be readily slapped around a trunk or branch of a tree.

The invention also provides for a common parking area water resistant display enclosure having a map which bears a scale diagram of points accessible from this point of entry. The enclosure can preferably have a metallic back surface equipped with a color-coded map legend depicting the activities allowable from the point of entry. Matching color coded magnets are provided for the hunter/outdoorsman to movably dispose over the map to indicate the location of the hunter/outdoorsman. In addition, the enclosure is preferably equipped with a motion activated illuminating device for illuminating the map. The illuminating device can be powered via battery or solar power storage cell.

The methodology of the invention is to provide the hunter/outdoorsman a way to accomplish safe hunter/outdoorsman practices by using multiple alerting or warning components. Hunter/outdoorsman's can go to a website of the instant invention, login in and mark their position on a geographic map area where he/she will be hunting or conducting outdoor activity on a particular day/time. This will be displayed on the website of the invention publicly for all to see.

The invention enables use of smart phone technology so one can access the website from anywhere telecommunication is available. Another additional feature is that the invention provides the ability to enter one's phone number. Once entering the time/date/area desired, the invention tracks the hunter/outdoorsman within such parameters via GPS or other phone tracking hardware, for example.

In addition, the hunter/outdoorsman prints out a map which designates the time and area in which he or she will be conducting such activity. This map is disposed in the water-resistant container which is equipped which a hook or like. Once at the hunting site point of entry, typically a parking area, the container is hung on the window to visibly display the location(s) of the hunter/outdoorsman. In addition, the container is preferably equipped with an illuminating member which will further call out to its presence to another hunter/outdoorsman visiting the same area.

The invention provides a mechanism by which outdoorsmen can communicate their location, usage, and duration to others to enhance and improve the quality of everyone's outdoor experience.

While hunting or conducting outdoor activity, the invention provides the hunter/outdoorsman with reflective spring metal slap sticks which can be slapped onto trees and branches as they walk through the area to mark their path. The slap sticks easily slap onto trees and branches to indicate position.

For hunters/outdoorsmen who are not members of the established network, the invention further provides a mechanism by which they can communicate their location, usage, and duration to others to enhance and improve the quality of everyone's outdoor experience. The common parking area water resistant display enclosure includes a map which bears a scale diagram of points accessible from this point of entry. Color coded magnets are provided for the hunter/outdoorsman to movably dispose over the map to indicate the location of the hunter/outdoorsman. In addition, the enclosure is preferably equipped with an illuminating device for illuminating the map.

Another aspect of the invention relates to an outdoor tracker system, which includes a magnetically connectable support back, a map connected to said support back which displays a particular geographic location wherein a plurality of activities are conducted, the map indicating a legend having a plurality of individually unique color coded legends corresponding to a predetermined activity for marking location of a hunter/outdoorsman on the map indicating the activity underway, and a plurality of individually unique color coded magnets corresponding to the color coded legends.

The advantage of the instant invention is that hunters or outdoorsman can mark a spot they wish to hunt or conduct outdoor activity prior to entering the site for a specific day and time in the future so others can see the availability and/or potential risks of the desired site. The invention provides for a safer hunting or outdoor activity environment and will let others know their location in advance as well as real time. The invention also encourages non-members of the system, who will be exposed to various elements of the system, to become willing participants and consumers of the instant invention.

### BRIEF DESCRIPTION OF THE DRAWINGS

FIG. 1 shows schematic of the invention.

FIG. 2 shows flow chart depicting a mode of operation of the invention.

FIG. 3 shows flow chart depicting a mode of operation of the invention.

FIG. 4A depicts a perspective view of a container and map of the invention.

FIG. 4B depicts a side view of a container and map of the invention.

FIG. 5A depicts a perspective view of a marking stick of the invention.

FIG. 5B depicts a end view of a marking stick of the invention.

FIG. 6 depicts a view of the common area map enclosure.

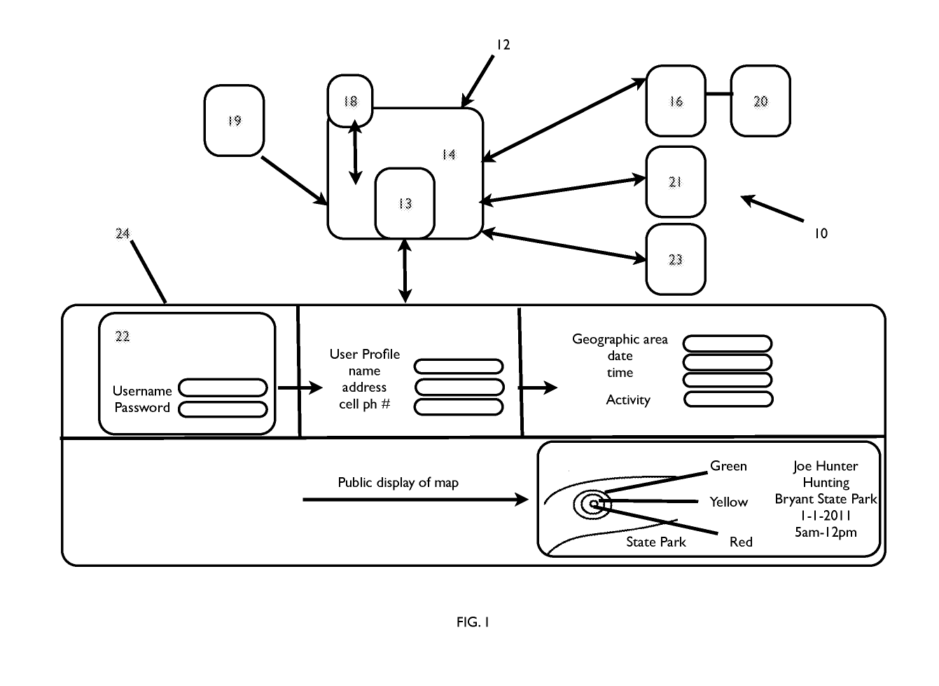

### DETAILED DESCRIPTION OF PREFERRED EMBODIMENTS

Referring now to the drawings, an outdoor tracker system with visual communication devices of the instant invention is generally designated by the numeral 10. One aspect of the system includes a web-based computer based system 12. The system 12 includes a web-based server computer 14 and a client computer 16 operably connected to the web-based server computer 14 via the Internet or other telecommunication link, wherein the client computer 16 can be a smart phone, desktop, laptop or other computer, for example, with browser software thereon. Operably associated with the system 12 is hunter/outdoorsman mapping software 18 which enables a user (hunter/outdoorsman) 20 access through client computer 16 to the web server computer 14. The hunter/outdoorsman mapping software 18 provides a landing page 22 which enables a user 20 to register and obtain a user name and password (or other unique identifying information data). Unique identifying data can preferably include one or more of an e-mail address, cellular number, as well as traditional, name, address, medical information, etc., which are stored as user data in database 13. Once registered, hunter/outdoorsman mapping software 18 provides the user 20 data fields for entering or selecting a particular geographic area(s) in which he or she will be located during a predetermined time and date. Accordingly, once the area(s), time(s) and date(s) are selected or entered, these are linked or associated with the unique user data of the user 20. In this way, a hunter/outdoorsman location can be obtained either by selecting a location within the mapping program or by way of manual entry of longitudinal and latitudinal coordinates. Upon location data being obtained or entered, the software 18 generates a map with the location of the hunter/outdoorsman thereon for display or printing. In addition, the hunter/outdoorsman software 18 provides for marking an anticipated date, time and location in which the hunter/outdoorsman is to be.

The hunter/outdoorsman mapping software 18 renders for public display the hunter/outdoorsman's location via hunter/outdoorsman website 24. The software 18 provides for safety and security features, an easy interface and instruction and with expandable functionality. The software 18 provides a notification feature to a registered user 20 to alert them of a potential other party entering the same area within the time and date in which the hunter/outdoorsman has preset.

This invention provides visual communication tools and software which enables scheduling and allocation of use. This enables public park and recreation divisions to more readily identify traffic within public lands. In addition, the invention has application to private land areas. In this way, emergency responders, guides, hunters, outfitters may also access the website 24 for traffic information.

The software 18 provides for multi-user web-based program, which is login/password protected. The software 18 provides for selection or entry of activity to be performed within the area, such as hunting, fishing, wild life watching, hiking, cycling, riding, archery, shooting, etc. and allows the user 20 to save one or more such type of activity as a default or preferred activity. In addition, other information may be added and saved with such user such as whether one likely to be disposed using a blind or elevated stand or is mobile in the designated site; conditions of the site (e.g., food sources, water, wind direction and speed) can also be entered and stored as part of a journal of data for the user to be stored in database 13. The software 18 can operatively interface with Google® Maps/Earth platform database 19 for mapping. In addition to providing visibility to all public and private lands to users, the software 18 provides highlighted formats in its rendering of a safe zone around your selected area, for example, the map can display as a function of the activity and maps zones using a predetermined color as a function of risk (e.g., red being high risk, yellow being somewhat risky, and green presenting no known risk based on data available in the database 13). The software 18 saves locations by usage date for visibility to other users and aids in safely managing area usage. The software 18 is programmed to save a predetermined number of active plus and saved locations for user 20. The software 18 renders scaled map data for printing by user 20 showing such features of usage and safe zones. The software provides for journal entry data to be logged and associated with each user 20 and location and such data is recallable, reviewable and exportable.

The software 18 is operably linked to real time weather database site 21 and site specific database 23, such as databases indicating data relative to number of blinds and stands in a particular location, food sources, soil treatments, bait sites, mineral stations, harvest records, trail pictures, prevailing wind direction and speeds, temperature, humidity, barometric pressure or other site specific information, for example. Once a user 20 has logged into the website 24 and selected an area time and date of interest, this data will be real time provided to the user 20 with up to date information.

Another aspect of the invention includes portable vehicle display boards. The boards are the primary visual communication devices and are preferably equipped with a display water resistant container 32 having a transparent front surface 34, a map 36 which bears a visual location 38 of a hunter/outdoorsman's location and which is disposed in the container 32 in a manner to be viewed through the transparent front surface 34. The container 32 can preferably have a back surface 40 equipped with a connector 42 for connecting the container 32 to the vehicle V, such as a hook for hanging the container 32 from a window W. In addition, the container 32 is preferably equipped with an illuminating device 44 for illuminating the map 36. In one case, the back surface 40 can be metal and a magnet 46 (preferably colored) is movably disposed over the map 36 to indicate the location of the hunter/outdoorsman. Optionally, the map 36 can also be printed bearing the location of the hunter/outdoorsman. The illuminating device 44 can be powered via battery or solar power storage cell.

The invention provides for a spring metal slap stick 50 (such as a slap stick) bearing a fluorescent material on the surface thereon. Optionally, the metal slap stick 50 can have a phosphorescent material which can be chemiluminescence or be made of a reflective material. The spring metal slap stick 50 can preferably be of a sufficient length such as several feet long to be readily slapped around a trunk or branch of a tree.

The invention also provides for a secondary visual communication device to allow non-members to communicate their location. This common parking area water resistant display 60 enclosure includes a map 62 which bears a scale diagram of points accessible from this point of entry. The enclosure can preferably have a metallic back surface equipped with a color-coded map legend 61 depicting the activities allowable from the point of entry, such as hunting game (red), bird watching (green), horseback riding (yellow), fishing (blue), hiking (brown), and cycling (orange). Matching color coded magnets 64 are provided for the hunter/outdoorsman to movably dispose over the map 62 to indicate the location of the hunter/outdoorsman. In addition, the enclosure is preferably equipped with an illuminating device 66 which is motion activated for illuminating the map 62. The illuminating device 66 can be powered via battery or solar power storage cell.

The methodology of the invention is to provide the hunter/outdoorsman a way to accomplish safe hunter/outdoorsman practices by using multiple alerting or warning components. Hunter/outdoorsman's 20 can go to website 24 of the instant invention, login in and mark their position on a geographic map area where user 20 will be hunting or conducting outdoor activity on a particular day/time. This will be displayed on the website 24 publicly for all to see.

The invention enables use of smart phone technology so user 20 can access the website 24 from anywhere telecommunication is available. An additional feature is that the software 18 provides the ability to enter one's phone number with the user data and thus once entering the time/area designated, the invention tracks the hunter/outdoorsman 20 within such parameters via GPS or other phone tracking hardware, for example.

The hunter/outdoorsman 20 preferably prints out a map which designates the time and area in which he or she will be conducting such activity. This map 36 is disposed in the water-resistant container 32 which is equipped which a hook or like. Once at the hunting site point of entry, typically a parking area, the container 32 is hung on the window W to visibly display the location(s) of the hunter/outdoorsman 20. In addition, the container 32 illuminating device 44 will further call out to its presence to another hunter/outdoorsman visiting the same area particularly in dark hours.

While hunting or conducting outdoor activity, spring metal slap sticks 50 are slapped onto trees and branches as they walk through the area to mark their path. The slap sticks 50 easily slap onto trees and branches to indicate position.

The advantage of the instant invention is that hunters or outdoorsman 20 can mark a spot they wish to hunt or conduct outdoor activity prior to entering the site for a specific day and time in the future so others can see the availability and/or potential risks of the site. The invention provides for a safer hunting or outdoor activity environment and will let others know their location in advance as well as real time.

The slap sticks 50 can be metal or plastic, paper, foil and which is preferably biodegradable and environmentally friendly. The slap sticks 50 can be of a color design as desired.

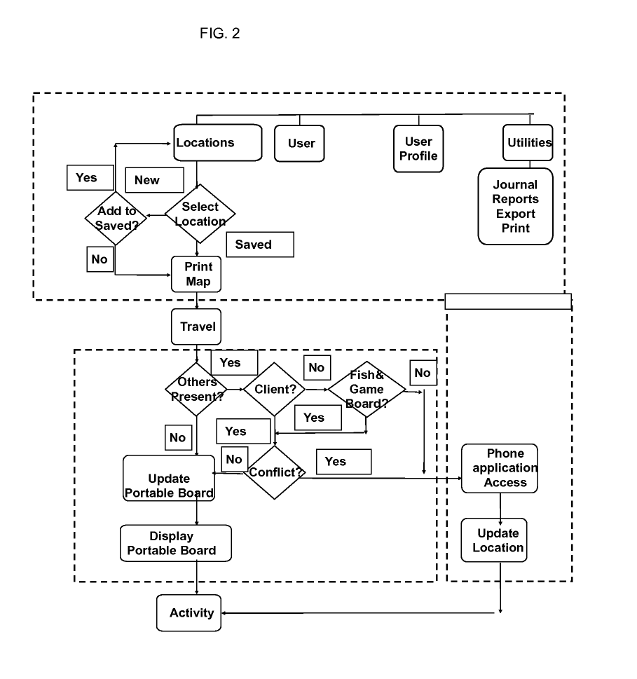

The drawings illustrate a couple of methodologies for practicing the instant invention. In FIG. 2, there is illustrated a method of use. Here, there is illustrated one operational mode where the user 20 enters the website 24, selects a location in which to conduct the outdoor activity, is provided an opportunity to save the location and then print a map bearing the location so selected.

The user 20 travels to the location. Upon arriving, to the location, the user checks for others present at the location, if a client of the present system, then it is determined whether a conflict exists. If so, the client uses a smart phone application to access the website 24 of the instant invention to update the location activity. If not or no others are present, then the portable board with map is displayed.

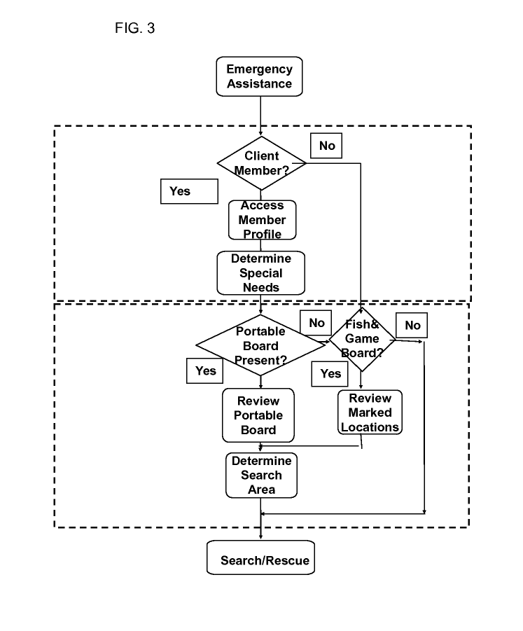

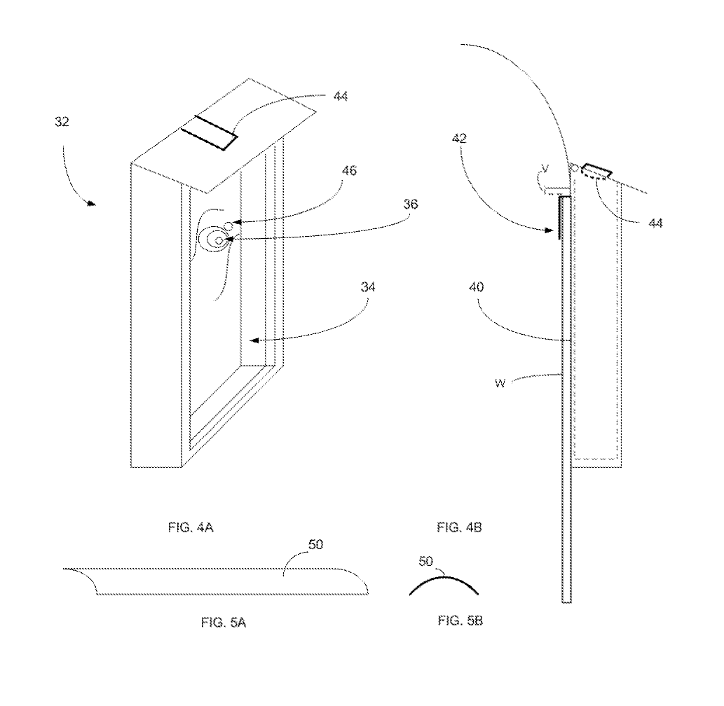

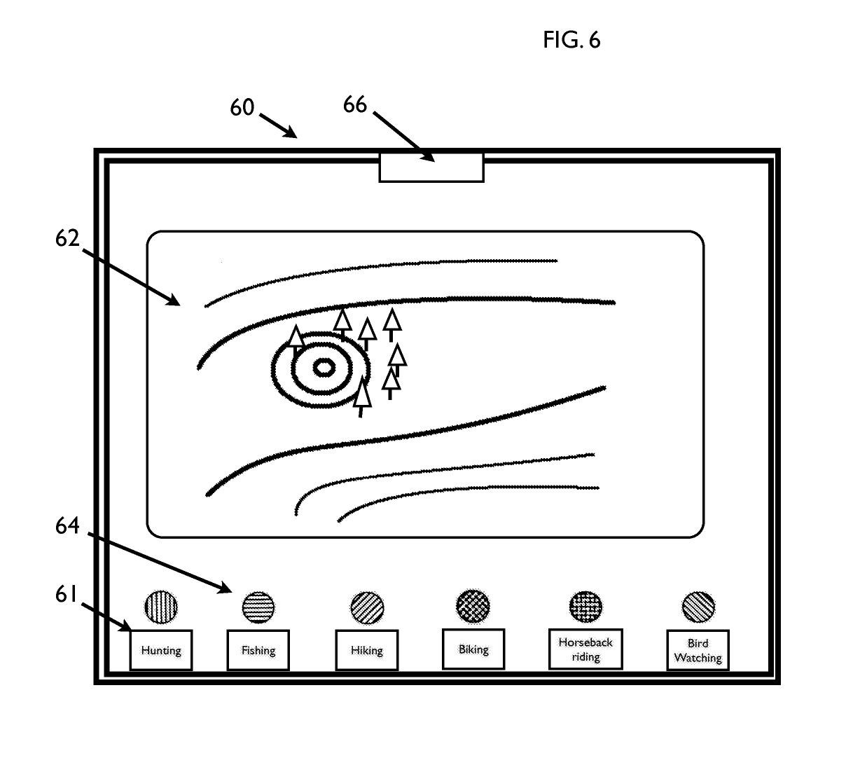

FIG. 3 depicts another mode of carrying out as aspect of the invention. Here, a responder (emergency assistance at location) can access the website 24 and see if the party is a client/user 20, access their profile, and determine special needs. The responder can check the location for the portable board, if not present, then report to Fish and & game or other authority who can review the location. If yes, the responder can review the portable board and determine the search area. A search and rescue can be dispatched according to the information obtained.

The system 10 of invention can be used for various applications and environments. With the instant invention, emergency responders can more readily locate and retrieve an outdoorsman who is injured to provide a safer outdoor environment.

While various embodiments of the present invention have been shown and described herein, numerous modifications, variations, and improvements are envisioned without departing from the invention herein. It is intended that these modifications, variations, and improvements be part of and within the scope of the appended claims.

What is claimed is:

1. An outdoor tracker system, which includes:
a web-based computer operably associated with hunter/outdoorsman mapping software, wherein said hunter/outdoorsman mapping software provides a login interface provides for user registration requiring unique identifying information data for said user to enable logging into a hunter/outdoorsman website, whereupon logging into said website said software provides for designating a hunter/outdoorsman geographic location and said software generates a map with said hunter/outdoorsman geographic location thereon for at least one of displaying on said website and for printing; and
a client computer having a web browser thereon operably connected to said web-based computer.

2. The outdoor tracker system of claim 1, wherein said hunter/outdoorsman mapping software further provides for entering a date and a time period for said hunter/outdoorsman geographic location.

3. The outdoor tracker system of claim 1, wherein said hunter/outdoorsman mapping software provides for selecting from a predetermined activity list and displays the activity conducted on said map in association with said hunter/outdoorsman geographic location.

4. The outdoor tracker system of claim 3, wherein said hunter/outdoorsman mapping software displays regions of said map as a function of said activity and maps zones using a predetermined color as a function of risk.

5. The outdoor tracker system of claim 4, wherein said hunter/outdoorsman mapping software provides real time tracking as a function of said unique identifying data.

6. The outdoor tracker system of claim 1, wherein said hunter/outdoorsman mapping software provides real time updates to a user as a function of said unique identifying data.

7. The outdoor tracker system of claim 1, wherein said hunter/outdoorsman mapping software provides for journal note data entry for a particular site which is associated with a particular user.

8. The outdoor tracker system of claim 1, which includes an illuminated portable board for displaying said map bearing said hunter/outdoorsman geographic location.

9. The outdoor tracker system of claim 8, which further includes a water resistant container having a transparent front surface, said map disposed therein to be viewed through said transparent front surface.

10. The outdoor tracker system of claim 9 wherein said container has a back surface equipped with a connector for connecting said container to a vehicle.

11. The outdoor tracker system of claim 9, wherein said container is equipped with an illuminating device for illuminating the map.

12. The outdoor tracker system of claim 9, wherein said container includes a metal back surface and a magnet movably disposed over said map.

13. The outdoor tracker system of claim 12, wherein said magnet indicates the location of the hunter/outdoorsman.

14. The outdoor tracker system of claim 11, wherein said illuminating device is powered power storage cell.

15. The outdoor tracker system of claim 1, which includes a spring metal slap stick for marking said location, wherein said spring metal slap stick is of a sufficient length to be readily slapped around and cling to a part of a tree.

16. The outdoor tracker system of claim 15, wherein said stick includes an illuminating material on a surface thereof.

17. The outdoor tracker system of claim 9, which includes a spring metal slap stick for marking said location, wherein said spring metal slap stick is of a sufficient length to be readily slapped around and cling to a part of a tree.

18. The outdoor tracker system of claim 17, wherein said stick includes an illuminating material on a surface thereof.

19. The outdoor tracker system of claim 1, which includes a plurality of individually unique color coded magnets corresponding to a predetermined activity for marking the location of the hunter/outdoorsman on said map indicating the activity underway.

20. An outdoor tracker system, which includes a magnetically connectable support back, a map connected to said support back which displays a particular geographic location wherein a plurality of activities are conducted, said map indicating a legend having a plurality of individually unique color coded legends corresponding to a predetermined activity for marking location of a hunter/outdoorsman on said map indicating the activity underway, and a plurality of individually unique color coded magnets corresponding to said color coded legends.
